(19) United States
(12) Patent Application Publication
(10) Pub. No.: US 2014/0249993 A1
(43) Pub. Date: Sep. 4, 2014

(54) METHOD AND APPARATUS FOR PERFORMING TRANSACTIONS VIA A SPONSOR ACCOUNT

(71) Applicants: Sreedhar Venkatraman, Bangalore (IN); Harsha Joshi, Bangalore (IN); Tuomo Saarikivi, Helsinki (FI); Zahid-Ahmed Admed, Westborough, MA (US)

(72) Inventors: Sreedhar Venkatraman, Bangalore (IN); Harsha Joshi, Bangalore (IN); Tuomo Saarikivi, Helsinki (FI); Zahid-Ahmed Admed, Westborough, MA (US)

(73) Assignee: Nokia Corporation, Espoo (FI)

(21) Appl. No.: 13/878,652

(22) PCT Filed: Sep. 21, 2011
(86) PCT No.: PCT/FI2011/050807

§ 371 Date: Apr. 23, 2014

(30) Foreign Application Priority Data
Oct. 13, 2010 (IN) 3031/CHE/2010

(51) Int. Cl. G06Q 20/08

(52) U.S. Cl. CPC G06Q 20/08
USPC 705/39

(57) ABSTRACT

An approach is presented for performing a transaction via a sponsor account. The transaction manager receives a request to sponsor payment for one or more client accounts by a sponsor account. Further, the transaction manager determines payment information associated with the sponsor account. Then, the transaction manager determines to associate the payment information with the one or more client accounts.

### BACKGROUND

Service providers and device manufacturers (e.g., wireless, cellular, etc.) are continually challenged to deliver value and convenience to consumers by, for example, providing compelling network services. The network services have become diversified and sophisticated, and thus users these days can perform various transactions and tasks using the network services such as e-mails, web browsing, purchasing of digital media, sports updates, searching for various information, etc. With the increase usage of the network services, one area of interest has been providing convenient options to pay for features and services provided by the network services. Users of the network services may pay for a certain service usage tariff to use the services within the limits defined by the service usage tariff. Traditionally, users of the network services make the payment for the service usage using an operator billing or a credit card. Although the operator billing and the credit card payment provide a quick and easy way to pay for the network services, not everyone has access to the operator billing or a credit card. Accordingly, service providers and device manufacturers face significant technical challenges in providing a convenient method to make payments to as many as users possible.

### SOME EXAMPLE EMBODIMENTS

Therefore, there is a need for an approach for performing transactions via a sponsor account.

According to one embodiment, a method comprises receiving a request to sponsor payment for one or more client accounts by a sponsor account. The method also comprises determining payment information associated with the sponsor account. The method further comprises determining to associate the payment information with the one or more client accounts.

According to another embodiment, an apparatus comprises at least one processor, and at least one memory including computer program code, the at least one memory and the computer program code configured to, with the at least one processor, cause, at least in part, the apparatus to receive a request to sponsor payment for one or more client accounts by a sponsor account. The apparatus is also caused to determine payment information associated with the sponsor account. The apparatus is further caused to determine to associate the payment information with the one or more client accounts.

According to another embodiment, a computer-readable storage medium carries one or more sequences of one or more instructions which, when executed by one or more processors, cause, at least in part, an apparatus to receive a request to sponsor payment for one or more client accounts by a sponsor account. The apparatus is also caused to determine payment information associated with the sponsor account. The apparatus is further caused to determine to associate the payment information with the one or more client accounts.

According to another embodiment, an apparatus comprises means for receiving a request to sponsor payment for one or more client accounts by a sponsor account. The apparatus also comprises means for determining payment information associated with the sponsor account. The apparatus further comprises means for determining to associate the payment information with the one or more client accounts.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of performing transactions via a sponsor account, according to one embodiment;

FIG. 2 is a diagram of the components of the transaction manager, according to one embodiment;

FIGS. 3A and 3B are flowcharts of a process for performing transactions via a sponsor account, according to one embodiment;

FIGS. 4A and 4B are diagrams of examples utilized in the processes of FIG. 3, according to various embodiments;

FIGS. 5A-5C are diagrams of user interfaces at the UE 101 utilized in the processes of FIG. 3 by a sponsor, according to various embodiments;

FIGS. 6A-6C are diagrams of user interfaces at the UE 101 utilized in the processes of FIG. 3 by a client, according to various embodiments;

FIGS. 7A-7C are diagrams of user interfaces utilized in the processes of FIG. 3 when a sponsor makes purchases for a client, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for performing transactions via a sponsor account are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

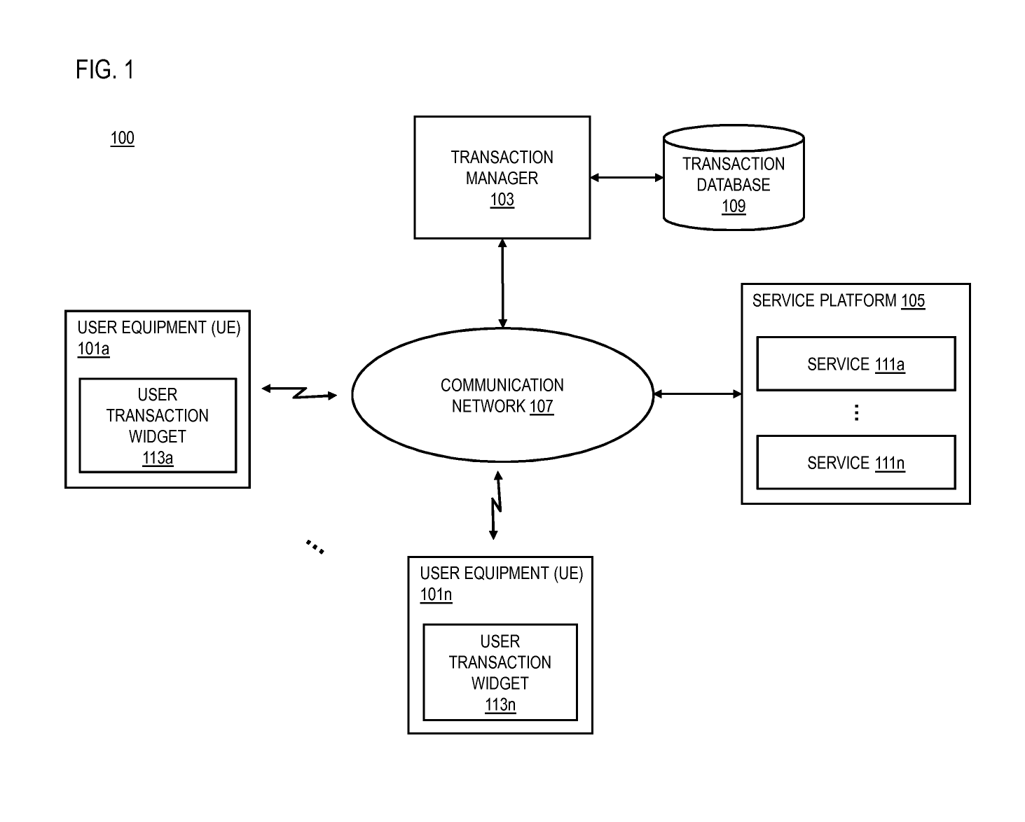

FIG. 1 is a diagram of a system capable of performing transactions via a sponsor account, according to one embodiment. As discussed previously, although methods have been developed to facilitate the payment for items, digital content, software and/or network services to be purchased online, these methods may not be available to everyone. In order to provide convenient methods of payment for the items such as software and/or network services, especially from a mobile device, operator billing or a credit card payments have been adopted for payment for purchases made online. However, not everyone may have access to such convenient payment method via the operator billing or the credit card payments. For example, if a user does not have a credit card, the user may not be able to access the credit card payment method. Especially in developing countries and other countries like India, the credit card and/or the operator billing may not be as commonly available as the developed country. For example, in some developing countries, less than 20 percent of the population owns a credit card. Further, generally, children under the age of 18 are not qualified to carry their own credit cards. In another example, one user may simply want to provide a way for others to access his/her account to make purchases. Accordingly, a convenient and easy method to make payments for others is desired.

To address this problem, a system 100 of FIG. 1 introduces the capability to perform transactions via a sponsor account. In one embodiment, the system 100 receives a request to sponsor payment for one or more client accounts by a sponsor account. A sponsor, which may be a user or an entity, may own the sponsor account which may provide payments for a client account that are subscribed to the sponsor account. The system 100 determines payment information associated with the sponsor account, and then associates the payment information with the one or more client accounts. Thus, even if the client account does not have means of payment for the purchases made by the client, the sponsor account can make payments for the client account. The payment information may be information related to convenient payment methods such as operator billing or credit card payment, such that the online service may associate the payment.

In one sample use case, a sponsor user may create and access a sponsor account in a service that manages transactions. This service may be single sign-on service that allows access of multiple software systems or services using the information provided by the account within the single sign-on service. The sponsor account may include payment information for making payments for services and/or downloads, for example. The payment information may be information regarding operator billing or credit card information, which enable quick and convenient transactions. Further, client accounts owned by other users may be added or subscribed to the sponsor account, such that purchases made by the client accounts subscribed to the sponsor account may be charged to the sponsor account according to the payment information (e.g., credit card information, operator billing information etc.). As the subscribed client accesses the online service to make purchases of items or services, the client may be presented with an option of charging the purchase to the sponsor account. If the client chooses this option, then the payment is charged to the sponsor account, and the payment is made according to the payment information provided by the sponsor account.

If the purchased item is digital content to be loaded to the client's device without an internet access (e.g., GPRS connectivity) or an item that needs to be picked up, then an e-ticket may be generated to be provided to the client's device upon the purchase. The e-ticket may be provided to the client's device via a text message. The e-ticket may also be provided to a retail store or a kiosk related to the online service. Then, the client may visit the retail store or the kiosk, and present the e-ticket provided to the client's device, which is verified against the e-ticket provided to the store or the kiosk. Upon successful verification, the item may be delivered to the client (e.g., the software may be downloaded to the client's device from a kiosk station).

As shown in FIG. 1, the system 100 comprises a user equipment (UE) 101 having connectivity to the transaction service 103 and the service platform 105 via a communication network 107. By way of example, the transaction manager 103 may provide features to create a sponsor account and to associate clients to the sponsor account such that the payment for clients' purchases may be charged to the sponsor account according to the payment information of the sponsor account. The transaction manager 103 may be connected to a transaction database 109 as a storage medium. The transaction database 109 may store information about user accounts, such as details about a sponsor account, and the client accounts that are associated with the sponsor account. The details about the accounts may include the name of the owner of the account, payment information associated with the account, any limitations or restrictions on the use of the account. Further, the service platform 105 may provide connection to the services 111a-111n. By way of example, the services may include services that provide internet connections, online shopping services, online media services (e.g. online media download and streaming), etc. In another embodiment, the transaction manager 103 may be within the service platform 105 or may be a part of one of the services 111a-111n. The transaction manager 103 communicates with the services 111a-111n to perform transactions (e.g., purchases of services or items) with the services 111a-111n. The UEs 101a-101n may include a user transaction widget 113 that is used to communicate with the transaction manager 103 such that the transaction manager 103 may create a sponsor account and/or add client accounts to the sponsor account. Therefore, a sponsor may use one of the UEs 101a-101n, and a client may use another one of the UEs 101a-101n. Then, by way of example, the sponsor may use one of the user transaction widgets 113a-113n of the UEs 101a-101n to set up a sponsor account and add the clients to the sponsor account using the transaction manager 103, and a client may use one of the user transaction widgets 113a-113n to perform transactions at the services 111a-111n via the sponsor account.

In one embodiment, the transaction manager 103 determines transactions associated with the client accounts, and presents the payment information associated with the sponsor account. For example, the client may use the client account to make a purchase, and then the transaction manager 103 may show an option of making payment of the purchase using the sponsor account. Thus, if the client selects an option to make payments for 24 hours of internet usage using the payment information associated with the sponsor account, the payment will be charged to the sponsor account. The transaction manager 103 may maintain a record of this transaction involving both the client accounts and the sponsor account. The transaction manager 103 may also generate a report of these transactions for presentation to the sponsor account, the client account, or a combination thereof.

In another embodiment, the client accounts may be associated with more than one sponsor accounts. Then, the sponsor accounts may be charged randomly when the client determines to use at least one of the sponsor accounts to make payments for a transaction. The sponsor accounts may be also be charged equally to make such payments. In another example, certain rules may be applied in charging multiple sponsor accounts. For example, one rule may have the transaction manager 103 charge the sponsor accounts according to the amount of money available in the sponsor accounts. Thus, if the client purchased a $30 worth of items and chooses to charge the sponsor accounts, and sponsor A has $100 and sponsor B has $200 available, then the transaction manager 103 may charge $10 to sponsor A and $20 to sponsor B, according to the amount of money available in each account. Alternatively, an equal amount may be charged to the sponsors, thus charging $15 for each of sponsor A and sponsor B. Further, the transaction manager 103 may determine a hierarchy of the sponsor accounts. Then, the sponsor accounts may be charged according to the hierarchy. For example, sponsor accounts in a higher hierarchy will be charged only after the sponsor accounts in a lower hierarchy are charged first and no longer has available money. Further, in another embodiment, a sponsor account may be created as a pooled account among the clients, wherein the clients contribute a certain amount of money to the sponsor account, and the clients who have contributed to the sponsor account (i.e. pooled account) may have access to the sponsor account to make payments.

In one embodiment, the transaction manager 103 may receive an input specifying limits corresponding to the client accounts that are associated with the payment information of the sponsor account. According to this input, the transaction manager 103 imposes these limits to the client accounts associated with the sponsor. The input may be made by a user (i.e. a sponsor) of the UE 101 to place limits to the client accounts associated with the sponsor account. This enables the sponsor to restrict access of the sponsor account by the client. The limits may be customized for each client. The limits may include a limit on the amount of money that can be spent by the client. For example, the amount limit may be set such that client A cannot spend more than $10 using the sponsor account, whereas client B can spend up to $20 using the sponsor account. The limit may include a time limit that may define a time period in which the client may use the sponsor account to make payments. For example, the sponsor may set the time limit such that the client can make payments using the sponsor account only until the end of the month. Further, the limit may also include a limit on a type of transaction or a limit on a category of a transaction item. Then, the transaction manager 103 may allow the client to use the sponsor account for a certain type of transactions or a certain category of a transaction item. These limits are advantageous in that they may provide the sponsor a control over the client accounts as to how much access to the sponsor account the clients can have. For example, if the parents are the sponsors and the children are the clients, the parents may desire to place limit on the children accounts and their access to the parents' account, to control budget and prevent excessive and/or unnecessary spending by the children.

Further, the transaction manager 103 may generate payment tokens for at least one of the client accounts based on the payment information. The payment tokens may be conveyed as a text message, an electronic mail, a code, a certificate, a credit, or a combination thereof. The tokens may be used as a proof for payment, which can be presented at a store or a kiosk to receive a service or an item associated with the payment. For example, a client may use a UE 101 to access the sponsor account to charge the sponsor account for the payment of digital content or software, and then receive a text message that includes an e-ticket. Then, the client may show this e-ticket displayed on the UE 101 to a clerk at the store or the kiosk as a proof of payment, and then the clerk may load the digital content or the software to the UE 101.

Therefore, the advantage of this approach is that the system 100 provides a convenient way to make a purchase, especially for a client without easy access to pay for purchases. This approach provides a novel way for a client to rely on the payment information of the sponsor account, wherein the sponsor account provides means for easy and convenient ways to pay for purchases. Thus, the client can use the sponsor account for purchases and the sponsor may control the access of the client to the sponsor account. Accordingly, means for performing transactions via a sponsor account is anticipated.

By way of example, the communication network 107 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the transaction manager 103 and the service platform 105 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

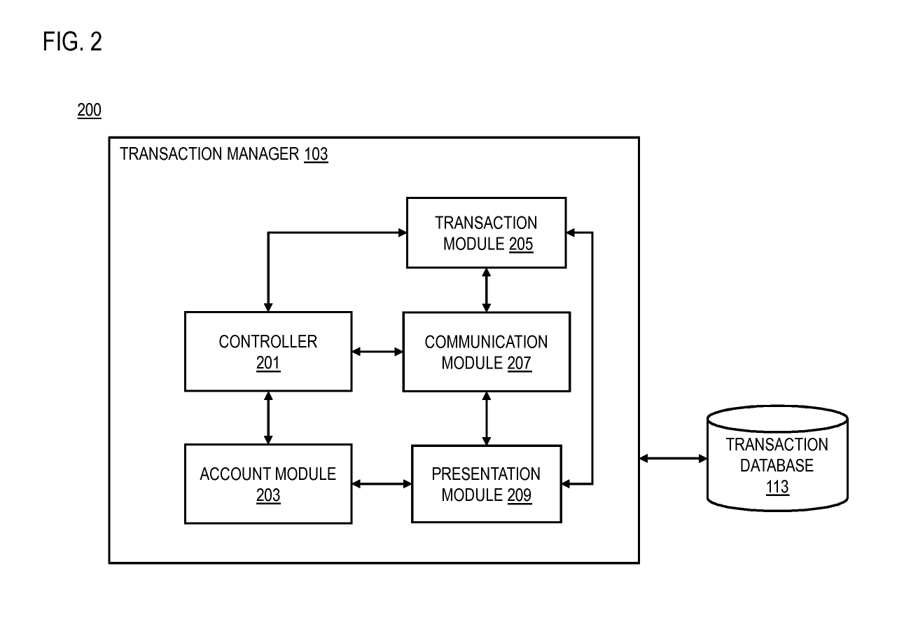

FIG. 2 is a diagram of the components of the transaction manager, according to one embodiment. By way of example, the transaction manager 103 includes one or more components for performing transactions via a sponsor account. It is contemplated that the functions of these components may be combined in one or more components or performed by other components of equivalent functionality. In this embodiment, the transaction manager 103 includes a controller 201, an account module 203, a transaction module 205, a communication module 207 and a presentation module 209.

The controller 201 oversees tasks, including tasks performed by the account module 203, the transaction module 205, the communication module 207 and the presentation module 209. The communication module 207 manages and controls any incoming and outgoing communications such as transfer of the data between the transaction manager 103 and at least one of the UE 101, the service platform and the transaction database 109. By way of example, the communication may include transfer of data or sending and receiving of a request, such as receiving of a request to sponsor payment client accounts by a sponsor account.

The account module 203 manages and controls various aspects involving the sponsor account(s) and the client accounts. The sponsor account may be managed via the account module 203. Further, the account module 203 may determine the payment information that is associated with the sponsor account. The account module 203 may also associate the payment information of the sponsor account with the client accounts. For example, by adding or subscribing the client accounts to the sponsor account, the payment information of the sponsor account may become associated with the client account. The communication module 207 may receive an input (e.g. an input from the UE 101) that imposes limit to the client accounts added to the sponsor account.

According to this input, the account module 203 associates the limits with the client accounts. The limits may place various restrictions that limit the usage of the sponsor account by the client accounts. The limits may include a time limit, an amount limit, a limit on a type of transaction, a limit on a category of a transaction item, or a combination thereof. The time limit may set a time during which the client account can use the sponsor account's payment information to make payments. The amount limit may be a limit on the amount of money or frequency of purchases that the sponsor account can sponsor for the client's accounts. The category on the type of transaction may allow some transactions such as paying for debt but not allow other transactions such as purchasing shoes. The limit on the category of the transaction item may allow purchases of some categories but not other categories. For example, if the clients are children and the sponsors are parents, the limit that the parents impose on the sponsor account may allow purchases of school supply categories, but not wine categories. These limits may be combined. For example, a time limit and an amount limit may be combined such that the client accounts may use the sponsor account only during the time imposed by the time limit and up to the amount imposed by the amount limit.

The transaction module 205 includes information regarding the payment information for the sponsor account and also communicates with the account module 203 to make payments for the client accounts using the sponsor account's payment information. Thus, the transaction module 205 may communicate with the account module 203 to determine transactions associated with the client accounts. Then, the transaction module 205 may communicate with the presentation module 209 to determine to present the payment information of the sponsor account as a payment option for the transactions. For example, this payment option may be presented at the UE 101, such that the client using the UE 101 may determine whether to use the sponsor account to make payments. The transaction module 205 may also generate a report of the transactions. The report may include the transactions performed by each of the clients, and the names of the sponsor accounts that were used for each transaction.

In one embodiment, the transaction module 205 may generate payment tokens for at least one of the client accounts based on the payment information. The transaction module 205 may convey the payment tokens as a text message, an electronic mail, a code, a certificate, a credit, or a combination thereof. The transaction module 205 may rely on the presentation module 209 to present the payment tokens at the UE 101. The client then may present the payment token displayed on the UE 101 to a clerk of a store or a kiosk, and the clerk may provide the client with services or items that correspond to the payment tokens.

Further, in another embodiment, there may be multiple sponsors for the clients. Each client may be associated with multiple sponsors, and thus each client may have multiple sponsor accounts that the client can access to make payments. The sponsor accounts may be assigned different hierarchies. In one example, the sponsor accounts may be accessed by the clients according to the hierarchies. For example, the sponsor accounts in a lower hierarchy will be charged with the payments by the client accounts first until these sponsor accounts run out of money, and then the sponsor accounts in a higher hierarchy may be charged for the remaining balance.

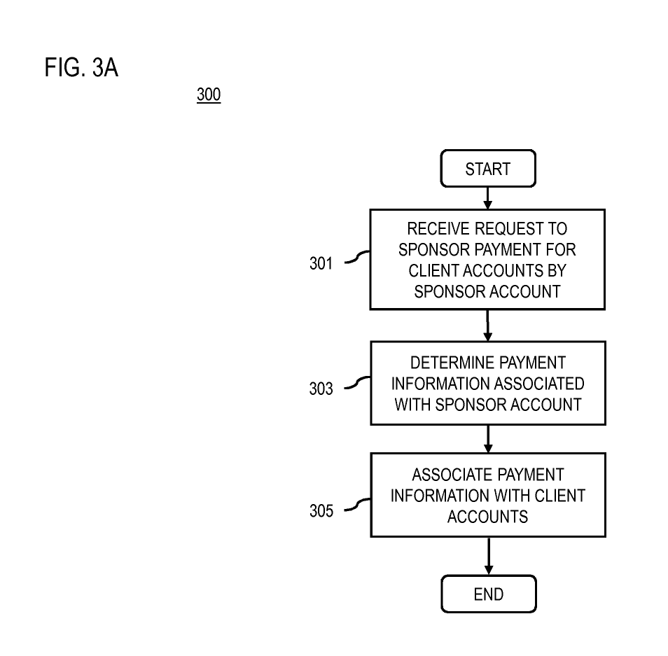

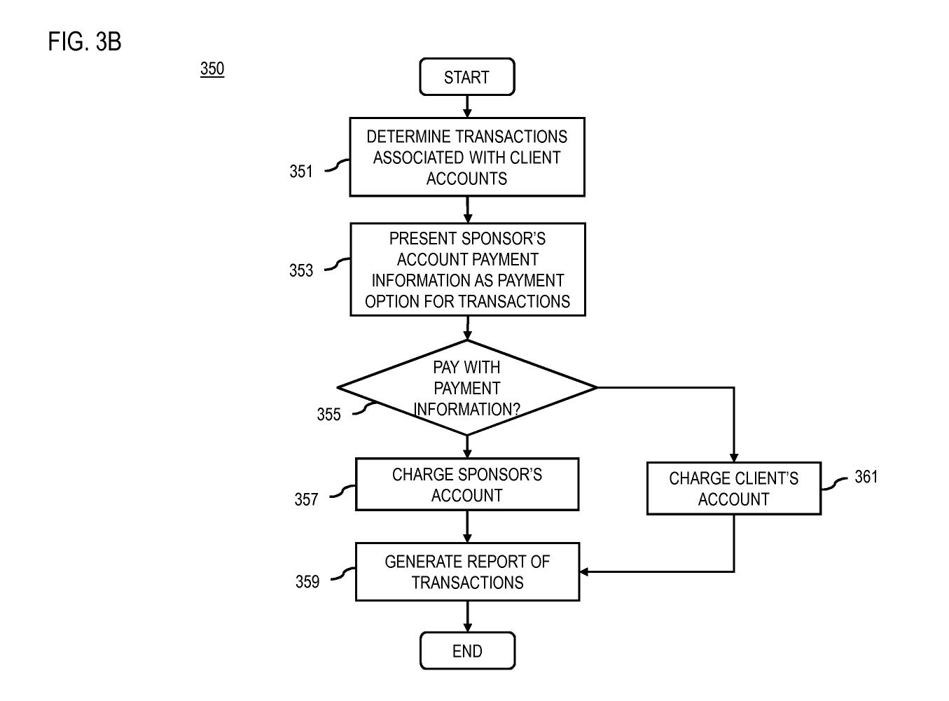

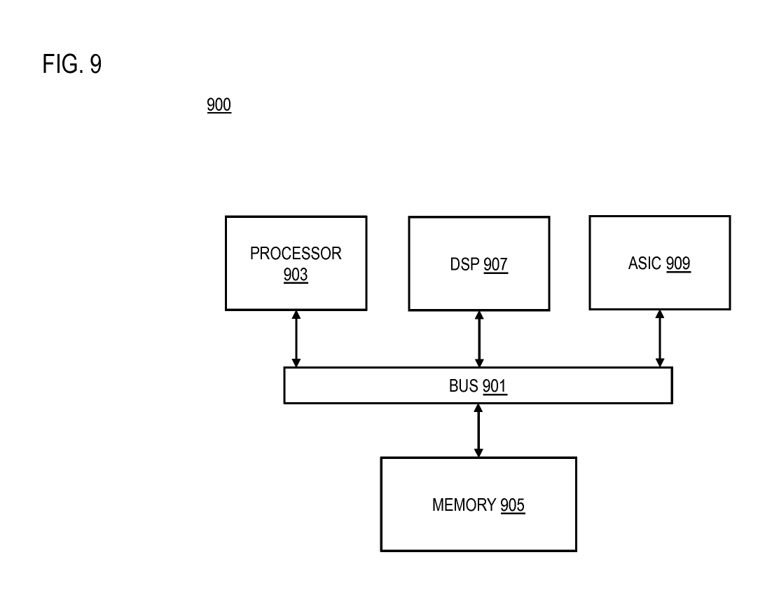

FIGS. 3A and 3B are flowcharts of a process for performing transactions via a sponsor account, according to one embodiment. In one embodiment, the transaction manager 103 performs the processes 300 and 350 and is implemented in, for instance, a chip set including a processor and a memory as shown in FIG. 9. FIG. 3A shows a process to associate the payment information of the sponsor account with the client accounts, according to one embodiment. In step 301, the transaction manager 103 receives a request to sponsor payment for client accounts by a sponsor account. Thus, this request is a request to make payments for the client accounts using the sponsor account. The client accounts may be owned by multiple users or may be owned by one user. In step 303, the transaction manager 103 determines payment information associated with the sponsor account. The payment information may be means for making the payment such as information on credit cards or operator billing. In step 305, the transaction manager 103 associates the payment information with the client accounts. Because the payment information of the sponsor account is associated with the client account, the client account may be able to access the sponsor account via the payment information, and make payments using the sponsor account based on the payment information.

In one embodiment, limits may be imposed to the client accounts. In particular, the transaction manager 103 may receive an input for specifying limits corresponding to at least one of the client accounts, and associate the limits with the at least one of the client accounts based on the input. The input may be from a sponsor, and thus may be transmitted from a sponsor's device (e.g., the UE 101). The limits may be limits imposed on the client account and may be related to accessing the sponsor account and/or the payment information of the sponsor account. Thus, the limits may include a time limit that defines a time during which the client account may access the sponsor account for payment of purchases, an amount limit as to how much the client can use from the sponsor account, a limit on a type of transaction placing various limits on different types of transaction, a limit on a category of a transaction item placing various limits on different categories of items, or a combination thereof.

FIG. 3B shows a flowchart of a process for using the sponsor account to complete a transaction, according to one embodiment. The process 350 may take place after the process 300 of associating the payment information of the sponsor account with the client accounts. In step 351, the transaction manager 103 determines transactions associated with the client accounts. Thus, these transactions are performed by the client. The transactions may include purchase of items as well as downloadable items such as software and digital media. The transactions may also include purchase of services. In step 353, the transaction manager 103 determines to present the payment information associated with the sponsor account as a payment option for the transactions. For example, a client may be provided with an option to make payments for the client's transaction using the sponsor account, instead of charging the client's account. The transaction manager 103 may also present different types of payment information associated with the sponsor account, such as different types of credit cards, operator billing option, etc., so that the client may choose at least one from the different types of payment information. In step 355, the transaction manager 103 determines whether to pay with the payment information of the sponsor account for the client accounts, according to the input in response to step 353. If the payment information of the sponsor account is to be used to pay for the client accounts, then the transaction manager 103 charges the sponsor account, as shown in step 357, and then generates a report of the transaction, as shown in step 359. If the payment information of the sponsor account is not to be used, the transaction manager 103 charges the client accounts for the payment, as shown in step 361, and then generates a report of the transaction, as shown in step 309.

In one embodiment, multiple sponsor accounts may be used for transactions by client accounts. The multiple sponsor accounts may be owned by the same sponsor and/or may be owned by different sponsors. In one embodiment, the multiple sponsor accounts may be accessed by the client accounts in a random fashion. In other words, a random sponsor account(s) may be selected to be charged for the payments by the client accounts. In another embodiment, a rule may be set in charging the sponsor accounts. For example, a rule may charge an equal amount of the payment throughout the sponsor accounts or may charge the sponsor accounts according to available money available in the sponsor accounts. Further, in another embodiment, a hierarchy may be determined for the sponsor accounts. Then, the payments by the client accounts may be charged according to the hierarchy of the sponsor accounts.

Further, after the payment is made, the transaction manager 103 may generate payment tokens for one of the client accounts based on the payment information. The payment tokens may be conveyed as a text message, an electronic mail, a code, a certificate, a credit, or a combination thereof. In one example, the payment token may be used as a proof of payment for corresponding items or services. The client may receive the payment tokens at the client device via SMS, and present the payment tokens at a store or a kiosk as a proof of payment. Then, a clerk at the store or the kiosk may verify the payment tokens against the record of the payment, and then provide the client with purchased items or services based on the verification results.

This process is advantageous in that it provides a client using the UE 101a simple and convenient way to make a purchase by utilizing the sponsor account's payment information. Thus, this process enhances the user experience in that the client can make a purchase even when the client does not have an easy access to means for the payment. The transaction manager 103 is a means for achieving this advantage.

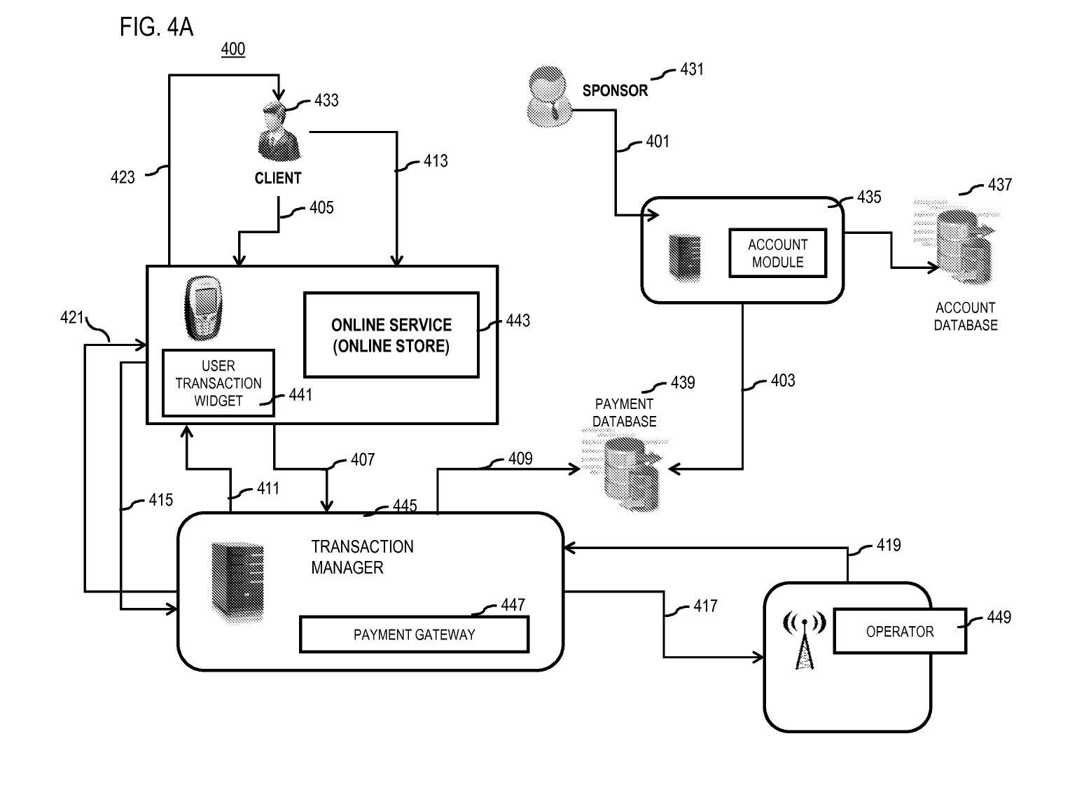

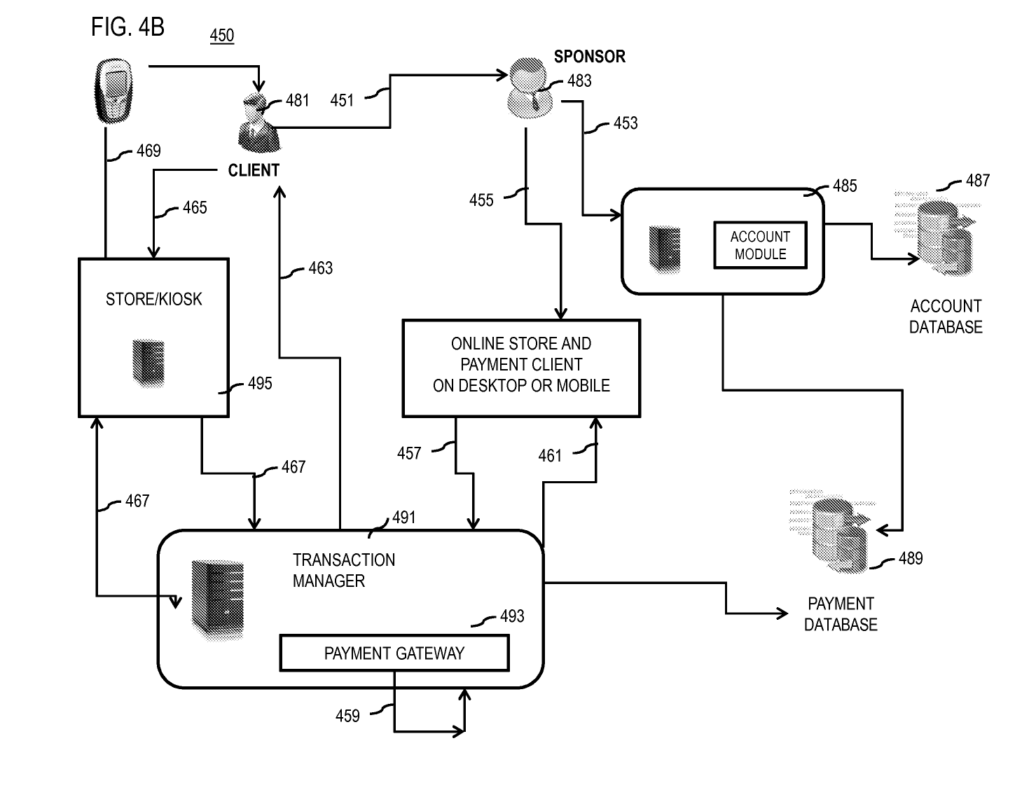

FIGS. 4A and 4B are diagrams of examples utilized in the processes of FIG. 3, according to various embodiments. FIG. 4A shows a diagram of an example for a client that has internet connectivity with the client's device and wants to purchase software for download. In step 401, the sponsor 431 adds details about the client 433 using the account module 435, which is connected to the account database 437 and the payment database 439. In step 401, the sponsor 431 may also change settings in the sponsor account such that purchases by the client may be charged to the sponsor account, and may also include limits on the purchases by the client that can be charged to the sponsor account. This account information may be stored in the account database 437. In step 403, the payment database 439 is updated with the option “pay through sponsor” as a stored payment method for the client. Then, if the client uses a user transaction widget 441 of the UE 101 to access an online store 443 and selects an item to purchase, the transaction widget 441 request the transaction manager 445 in step 407 to retrieve payment options available based on client database, as performed in step 409. The payment options available via the sponsor are then returned to the user transaction widget 441, via step 411. Then, in step 413, the client may use the user transaction widget 441 to select a payment option to make payment using the sponsor account, and confirm the purchase, such that the payment via the sponsor may be requested via step 415. The request is processed by the payment gateway 447, and appropriate charge for the purchase is made. If the payment is via the sponsor's credit card, the payment request may be made to the operator 449 via step 417. Upon approval of the credit card payment, the operator 449 returns a payment success notification via step 419. Then, in step 421, the payment confirmation is returned to the user transaction widget 441 along with a specific address or instructions to download the software purchased via the payment. The client can view the payment confirmation in step 423 and download the software via the instructions or the address provided in the payment confirmation.

FIG. 4B shows a diagram of an example for a client that does not have internet connectivity in the client's device and wants to purchase software for the client's device. In step 451, the client 481 provides the client international mobile equipment identity (IMEI) number, a mobile device number, and/or any other identifier associated with the client or the client's device to the sponsor 483. In step 453, the sponsor 483 adds the details about the client 481 using the account module 485, which is connected to the account database 487 and the payment database 489. In step 453, the sponsor 483 may also change settings in the sponsor account such that purchases by the client may be charged to the sponsor account, and may also include limits on the purchases by the client that can be charged to the sponsor account. In step 455, the sponsor 483 may access the online store and purchase items for the client 481. Then, in step 457, the online store communicates with the transaction manager 491 and the payment gateway 493 to make payments for the client 481 using the sponsor account, by providing the client IMEI number and a mobile device number associated with the client's device. In step 459, the payment for the item is charged to the sponsor account via the payment gateway 493, and the transaction manager 491 generates a payment token (e.g., an e-ticket of the payment). Then, the e-ticket is returned to the sponsor's device in step 461, and is also sent to the client's device via SMS in step 463. In step 465, the client 481 can take the client's device to a store/kiosk 495 (e.g., a physical store or kiosk), and request that the purchased item to be installed to the client's device or otherwise redeemed by presenting the e-ticket. In this way, the client's device may redeem or have access to content (e.g., digital content) even if the device has no network (e.g., Internet) access. Then, in step 467, the e-ticket presented by the client 481 is verified against the information in the transaction manager 491. The verification results of the e-ticket are returned in step 467, and upon verification, the purchased item is installed to the client's device in step 469.

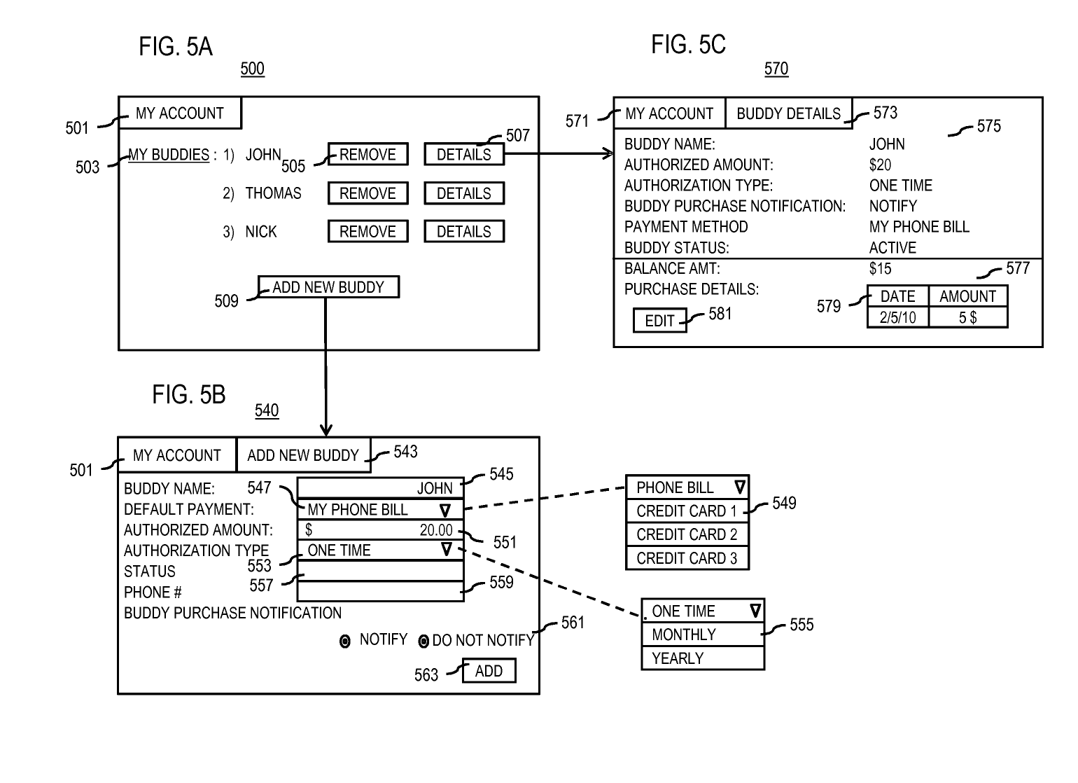

FIGS. 5A-5C are diagrams of user interfaces at the UE 101 utilized in the processes of FIG. 3 by a sponsor, according to various embodiments. FIG. 5A shows an user interface 500 showing an account setting at a sponsor's device to set the clients (i.e. buddies) that can access the sponsor account for payment. The title 501 shows that the user interface shows the sponsor's account, “My Account.” In the sponsor account, the user interface shows a list of the sponsor's clients under the My Buddies list 503, which shows John, Thomas and Nick as the sponsor's clients (i.e. buddies). The Remove button 505 may be selected to remove the corresponding client from the My Buddies list 503, and the Details button 507 may be selected to display and/or customize details about the corresponding client. The Add New Buddy button 509 may be selected to add a new client to the My Buddies list 503.

If the Add New Buddy button 509 is selected, the client details user interface 540 may be displayed, such that details about the client may be entered. The title screen 541 still shows that the user interface is for the sponsor account “My Account.” The second title screen 543 shows that this interface is used to add a new buddy. The buddy name section 545 may be selected to enter the name of the client, which is “John” in this example. The default payment section 547 may be selected to select payment information associated with the sponsor account. When the default payment section 547 is selected, a pull down menu 549 may be displayed to show available options such as the phone bill, credit card 1, credit card 2, credit card 3, etc. for the default payment. In this case, the phone bill option is selected to bill the payment to the phone bill as an operator billing method. The authorized amount section 551 may be selected to enter the amount of money authorized for the client accounts to use, which is set to $20 in this case. The authorization type section 553 may be selected to set the type of authorization based on time. Upon selection of the authorization type section 553, a pull down menu 555 may be displayed to show available options for the authorization type, such as one time, monthly and yearly. One time authorization allows only one time access by a client account to the authorized amount. Monthly or yearly authorization allows the access by the client to the authorized amount once a month or once a year, respectively. The status section 557 may be set to active or inactive, to set the sponsor account to be available or unavailable for the buddy John, in this example. The phone number section 559 may be used to enter the phone number of the client (i.e. buddy). Further, the buddy purchase notification section 561 may be set to “notify” or “do not notify,” to set whether to notify the sponsor when the client account uses the sponsor account to make payments. The Add button 563 may be selected to add the client to the list with the information entered in this user interface 540.

If the Details button 507 is selected, the user interface 570 showing the details about the corresponding client is displayed. The title bar shows that the user interface 570 is for the sponsor account, and the second title bar 573 showing that the user interface displays buddy details. The details section 575 shows details about the client (i.e. buddy), including the buddy name, the authorized amount, the authorized type, the buddy purchase notification, the payment method, the buddy status. The balance amount section 577 shows the available money in the sponsor account that the client “John” can access to make payments. The purchase details show the details on the purchases by the client “John” using the sponsor account. The edit button 581 may be selected to edit the details about the client (i.e., buddy) shown in the details section 575.

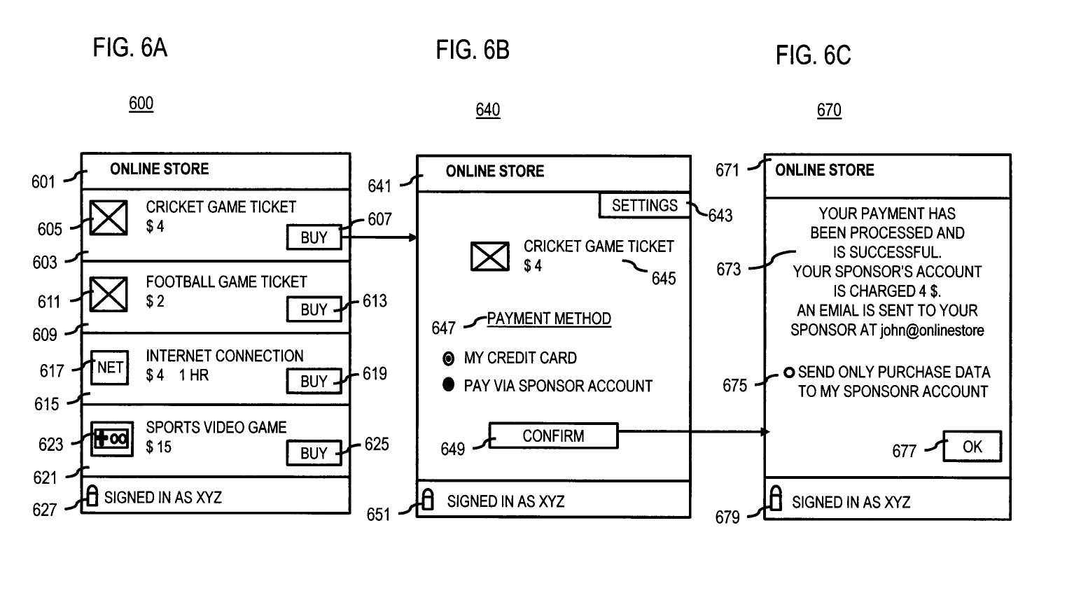

FIGS. 6A-6C are diagrams of user interfaces at the UE 101 utilized in the processes of FIG. 3 by a client, according to various embodiments. FIG. 6A shows a user interface 600 for a client to make purchases from a service such as an online store. The title 601 shows that this is a user interface for online shopping from the online store. The cricket game ticket section 603 shows the price (e.g. $4) of the cricket game ticket, and shows an icon 605 corresponding to the ticket. If the buy option 607 is selected, then more options may be shown to finish the purchase of the cricket game ticket. Similarly, the football game ticket section 609 shows the price of the football game ticket as well as the corresponding icon 611 and the buy option 613. Further, the internet connection section 615 and the sports video game section 621 show corresponding prices, icons 617 and 623 and the buy options 619 and 625. The status bar 627 shows that the client XYZ is currently signed in.

FIG. 6B shows a user interface 640 that is displayed when the buy option 607 for the cricket game ticket is selected. The title 641 shows that this interface 640 is for shopping at the online store. The second title 643 shows that the interface 640 is for purchase settings. The purchase item section 645 shows that the settings are for the purchase of the cricket game ticket that costs $4. The payment method option 647 shows a selectable option between “My Credit Card” and “Pay Via Sponsor Account.” In this example, the option to pay via the sponsor account is selected. The confirm button 649 may be selected to confirm the selection made in the payment method option 647 and finish the purchase. The status bar 651 shows that the client XYZ is currently signed in.

FIG. 6C shows a user interface 670 after the confirm button 649 has been selected. The message section 673 displays a text showing that the purchase has been made and the sponsor account has been charged for the purchase, and the email notification has been sent to the sponsor's email address. The notification option 675 may be selected to limit the content of the notification to only the purchase data. The OK button 677 may be selected to confirm that the client has read the message section 673, and has made a decision as to the notification option 675. The status bar 679 shows that the client XYZ is currently signed in.

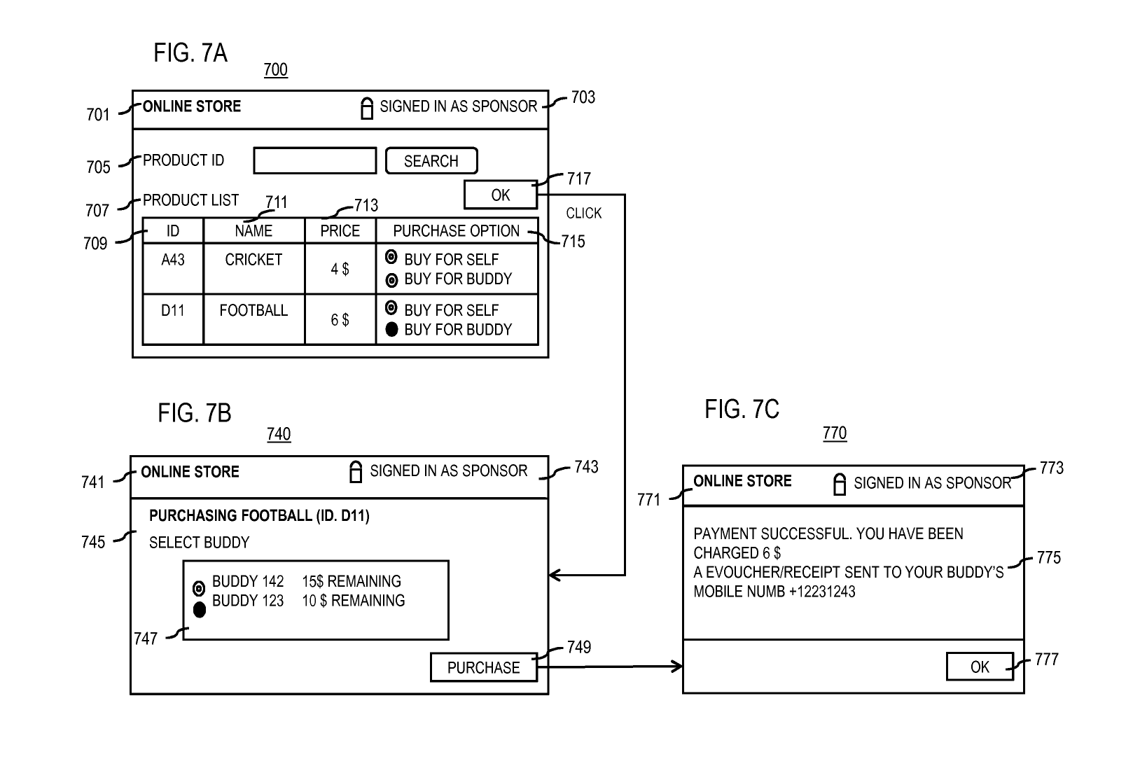

FIGS. 7A-7C are diagrams of user interfaces utilized in the processes of FIG. 3 when a sponsor makes purchases for a client, according to various embodiments. In FIGS. 7A-7C, the user interfaces enable the sponsor to make purchases for the client. FIG. 7A shows a user interface 700 for a sponsor. The title 701 shows that the user interface 700 is for online shopping at the online store, and the status 703 shows that the sponsor is currently signed in for the user interface 700. The product ID search option 705 enables the sponsor to search products based on a product identifier. The product list 705 lists the product by the ID 709, and displays corresponding names for the products 711, corresponding prices 713, and the purchase option 715. The purchase option provides an option of purchasing the product for self (i.e. sponsor) and for a buddy (i.e. client). In this example, the option to buy for buddy is selected for the football. When the selection of the purchase option is completed, the OK button 717 may be selected to proceed to the next step in the purchase, which is shown in the user interface 740 in FIG. 7B.

In FIG. 7B, the user interface 740 shows an option to select a client for whom the purchase is to be made. The title 741 shows that this interface 740 is for shopping at the online store, and the status 743 shows that the sponsor is currently signed in. The select buddy option 745 shows that this purchase is for the football which has an ID of D11, and shows an option to select between two different clients, buddy 142 and buddy 123. The select buddy option 747 also shows that buddy 142 has $15 remaining to spend using the sponsor account, and buddy 123 has $10 remaining to spend using the sponsor account. In this example, buddy 123 is selected to purchase the football for buddy 123. The purchase button 749 may be selected to finish purchase. When the purchase button 749 is selected, the user interface 770 shown in FIG. 7C is displayed. The title 771 shows that this interface 740 is for shopping at the online store, and the status 773 shows that the sponsor is currently signed in. The message section 775 shows that the payment has been successfully made, and an e-voucher is sent to the buddy's mobile number. Then, the buddy may show the e-voucher to a store clerk to pick up the football that was purchased for him by the sponsor. The OK button 777 may be selected to confirm that the sponsor read the information displayed in the message section 775.

The processes described herein for performing transactions via a sponsor account may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

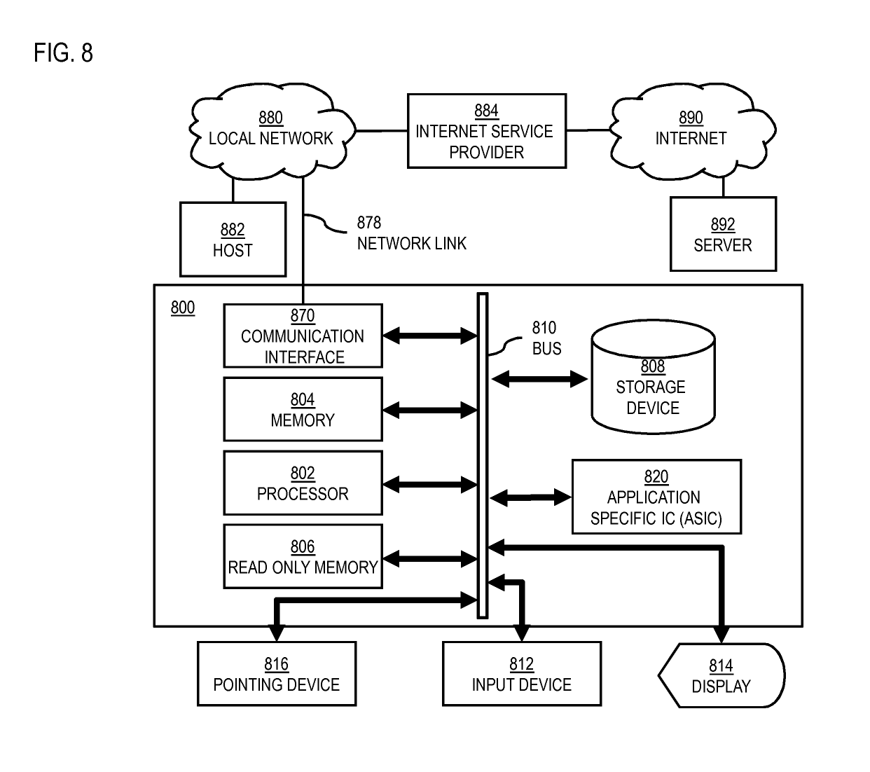

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to perform transactions via a sponsor account as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of performing transactions via a sponsor account.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to performing transactions via a sponsor account. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for performing transactions via a sponsor account. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for performing transactions via a sponsor account, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 107 for performing transactions via a sponsor account.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to perform transactions via a sponsor account as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of performing transactions via a sponsor account.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to performing transactions via a sponsor account. The memory 905 also stores the data associated with or generated by the execution of the inventive steps.

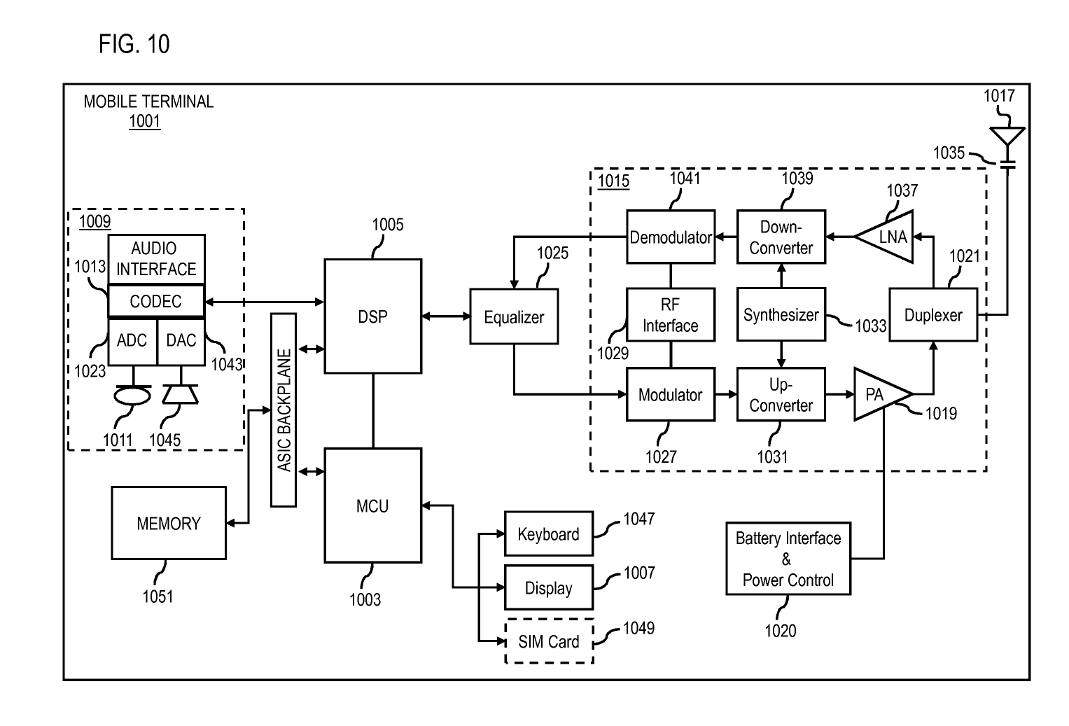

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of performing transactions via a sponsor account. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of performing transactions via a sponsor account. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to perform transactions via a sponsor account. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-30. (canceled)

31. A method comprising:
receiving a request to sponsor payment for one or more client accounts by a sponsor account;
determining payment information associated with the sponsor account; and
determining to associate the payment information with the one or more client accounts.

32. A method of claim 31, further comprising:
receiving an input for specifying one or more limits corresponding to at least one of the one or more client accounts; and
determining to associate the one or more limits with the at least one of the one or more client accounts based on the input.

33. A method of claim 32, wherein the one or more limits include a time limit, an amount limit, a limit on a type of transaction, a limit on a category of a transaction item, or a combination thereof.

34. A method of claim 31, further comprising:
determining one or more transactions associated with the one or more client accounts; and
determining to present the payment information as a payment option for the one or more transactions.

35. A method of claim 34, further comprising:
determining to generate a report of the one or more transactions for presentation to the sponsor account, the client account, or a combination thereof.

36. A method of claim 31, further comprising:
determining to associate at least one of the one or more client accounts with one or more other sponsor accounts.

37. A method of claim 36, further comprising:
determining a hierarchy of the sponsor account and the one or more other sponsor accounts.

38. A method of claim 36, further comprising:
determining to complete the one or more transactions based, at least in part, on the sponsor account, the one or more other sponsor accounts, or a combination thereof.

39. A method of claim 31, further comprising:
determining to generate one or more payment tokens for at least one of the one or more client accounts based, at least in part, on the payment information.

40. A method of claim 39, further comprising:
determining one or more identifiers associated with one or more devices of the at least one client account,
wherein the one or more payment tokens is further based, at least in part, on the one or more identifiers.

41. An apparatus comprising:
at least one processor; and
at least one memory including computer program code for one or more programs,
the at least one memory and the computer program code configured to, with the at least one processor, cause the apparatus to perform at least the following,
receive a request to sponsor payment for one or more client accounts by a sponsor account;
determine payment information associated with the sponsor account; and
determine to associate the payment information with the one or more client accounts.

42. An apparatus of claim 41, wherein the apparatus is further caused to:
receive an input for specifying one or more limits corresponding to at least one of the one or more client accounts; and
determine to associate the one or more limits with the at least one of the one or more client accounts based on the input.

43. An apparatus of claim 42, wherein the one or more limits include a time limit, an amount limit, a limit on a type of transaction, a limit on a category of a transaction item, or a combination thereof.

44. An apparatus of claim 41, wherein the apparatus is further caused to:
determine one or more transactions associated with the one or more client accounts; and
determine to present the payment information as a payment option for the one or more transactions.

45. An apparatus of claim 44, wherein the apparatus is further caused to:
determine to generate a report of the one or more transactions for presentation to the sponsor account, the client account, or a combination thereof.

46. An apparatus of claim 41, wherein the apparatus is further caused to:
determine to associate at least one of the one or more client accounts with one or more other sponsor accounts.

47. An apparatus of claim 46, wherein the apparatus is further caused to:
determine a hierarchy of the sponsor account and the one or more other sponsor accounts.

48. An apparatus of claim 47, wherein the apparatus is further caused to:
determine to complete the one or more transactions based, at least in part, on the sponsor account, the one or more other sponsor accounts, or a combination thereof.

49. An apparatus according to any one of claim 41, wherein the apparatus is further caused to:
determine to generate one or more payment tokens for at least one of the one or more client accounts based, at least in part, on the payment information.

50. An apparatus of claim 49, wherein the apparatus is further caused to:
determine one or more identifiers associated with one or more devices of the at least one client account,
wherein the one or more payment tokens is further based, at least in part, on the one or more identifiers.
